(19) United States
(12) Patent Application Publication
(10) Pub. No.: US 2016/0350012 A1
(43) Pub. Date: Dec. 1, 2016

(54) DATA SOURCE AND DESTINATION TIMESTAMPS

(71) Applicant: HEWLETT PACKARD ENTERPRISE DEVELOPMENT LP, Houston, TX (US)

(72) Inventors: Roopesh Kumar Tamma, Fremont, CA (US); Jin Wang, Fremont, CA (US); Siamak Nazari, Fremont, CA (US); Srinivasa D Murthy, Fremont, CA (US)

(21) Appl. No.: 15/114,765

(22) PCT Filed: Mar. 20, 2014
(86) PCT No.: PCT/US2014/031347

§ 371 Date: Jul. 27, 2016

(51) Int. Cl. G06F 3/06

(52) U.S. Cl. CPC G06F 3/0619; G06F 3/0689; G06F 3/065; G06F 3/0665

(57) ABSTRACT

Techniques to copy data from a source region to a destination region, and to update in cache a source region timestamp and a destination region timestamp.

### BACKGROUND

Storage systems such as storage networks, storage area networks, and other storage systems, have controllers and storage disks for storing data. Client or host devices may request to access the data in the storage.

A storage tier approach may be implemented in the storage system so that data is stored in different respective types of storage based on characteristics of the data, frequency of access to the data, user or client policies, and so forth. In particular examples, frequently-accessed or high-priority data are stored in faster and more expensive storage, whereas rarely-accessed or low-priority data are stored in slower and less expensive storage.

In operation, the storage tiering may involve moving data between fast and slow storage tiers based on data access patterns. Consequently, the records or representations in the storage system of the relationships between the data and storage locations may need to be updated to reflect the new location of the moved data.

### BRIEF DESCRIPTION OF THE DRAWINGS

Certain exemplary embodiments are described in the following detailed description and in reference to the drawings, in which:

FIG. 1 is a block diagram of a storage system with controller nodes and storage arrays in accordance with examples;

FIG. 2 is a block diagram of an controller node of the storage system of FIG. 1 in accordance with examples;

FIG. 3 is a process flow diagram of a method of operating a storage system in accordance with examples; and

FIG. 4 is a block diagram showing a tangible, non-transitory, computer-readable medium that stores code configured to direct a storage system in accordance with examples.

### DETAILED DESCRIPTION OF SPECIFIC EMBODIMENTS

Certain examples disclosed herein accommodate adaptive optimization or adaptive adjustment in storage tiering where data can be moved between storage tiers based on input/out (I/O) access patterns and other factors. For example, data that is “hot” can be moved to faster (but costlier) storage, while data that is “cold” can be moved to slower, cheaper storage. Advantageously, in some examples, such data movements or data migration may be performed while the data continues to be accessed by client or host applications.

Indeed, the storage system may remain online or substantially online and available to client or hosts while the data is being moved. Again, the data may be moved in response to the adaptive management of the data with respect to the storage tier levels based on access patterns, for example.

In particular examples, the metadata, mapping, mapping tables, or virtualization maps, may be updated or changed in storage controller cache to reflect the data movement without blocking or substantially blocking host I/O, or without quiescing host I/O. Consequently, response times to the client or host may be substantially unaffected by the data movement in the storage tiering. Thus, spikes in host I/O response associated with conventional cache invalidation and remapping may be avoided or significantly avoided.

As discussed below, such avoiding of blocking host I/O requests may be facilitated with the introduction of a timestamp in controller node cache. The timestamp or timestamps may be with respect to the source and destination storage regions of the moved data.

During the moving or copying of the data, new write data received at the controller may be written to both the source region and the destination region. Once the copying is complete, the virtualization maps on the controller nodes are changed so that the maps now point to the destination region as the storage location for the moved data. At the same time, as indicated, timestamps associated with the source and destination regions are updated in the controller node. Updating the timestamps associated with the source and destination regions may cause clean cache data to be detected as stale, and dirty cache data detected via mismatched timestamps.

Thus, in some examples, data movement with the dynamic or adaptive enhancement of data location with regard to the storage tiers based on data access patterns (e.g., how frequently the data is accessed) and other considerations may be practiced without substantial proactive cache invalidation or without blocking host I/O requests. Moreover, examples of the techniques may be implemented in a distributed shared-nothing or shared-little architectures, or other architectures, where data is striped across multiple controllers providing read and write caching, for instance.

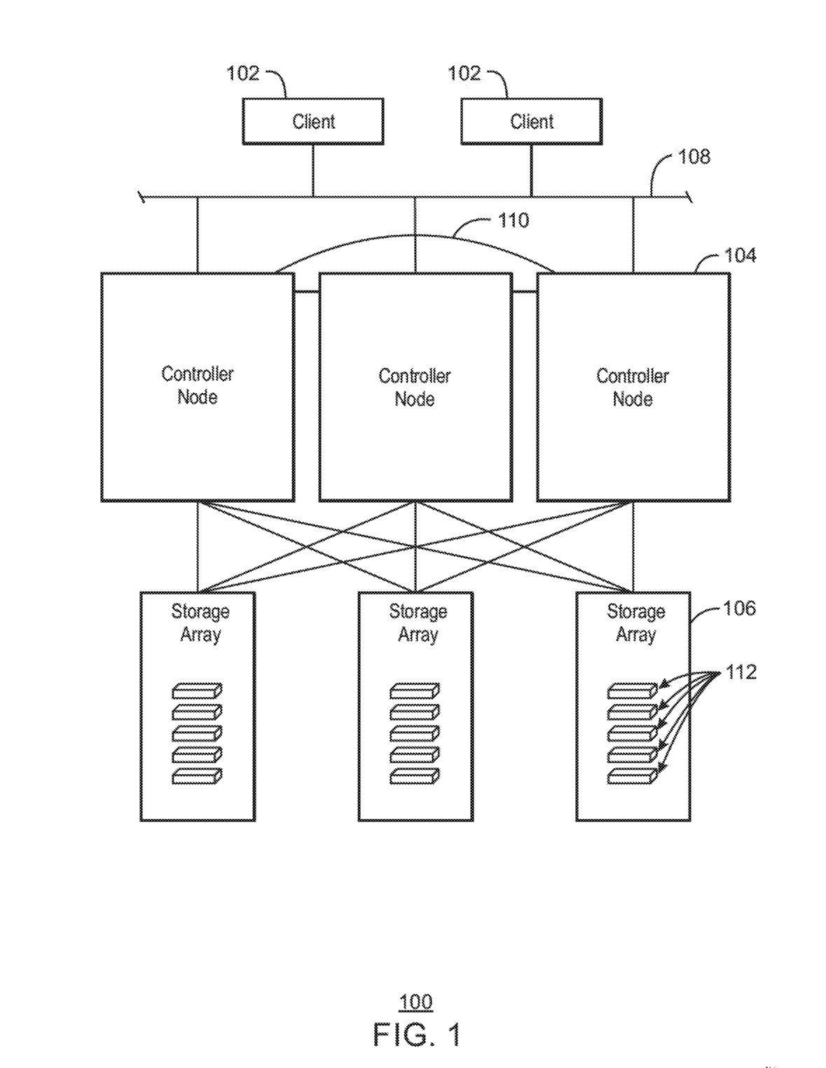

FIG. 1 is an exemplary storage system 100 that provides data storage resources to client computers 102. The client computers 102 may be general purpose computers, workstations, personal computers, mobile computing devices, and the like. The client computers 102 may be considered a host or outside client. The storage system 100 may be associated with data storage services, a data center, cloud storage, a distributed system, storage area network (SAN), virtualization, and so on. Examples of a SAN or similar network may include a Fibre Channel (FC) topology. For instance, a switched fabric having fibre channel switches may be employed. Of course, other topologies are applicable. In the illustrated example, the storage system 100 includes storage controller nodes 104. The storage system 100 also includes storage arrays 106, which are controlled by the controller nodes 104.

The client computers 102 can be coupled to the storage system 100 through a network 108, which may be a local area network (LAN), wide area network (WAN), a SAN, or other type of network. On the other hand, a client device or client computer 102 may be coupled more directly to a controller node 104 of the storage system 100. Moreover, in some examples, the storage system 100 may include host servers (not shown) operationally disposed between the client computers 102 and the controller nodes 104.

Each of the controller nodes 104 may be communicatively coupled to each of the storage arrays 106. Each controller node 104 can also be communicatively coupled to each other controller node by an inter-node communication network 110, for example.

The client computers 102 can access the storage space of the storage arrays 106 by sending I/O requests, including write requests and read requests, to the controller nodes 104. The controller nodes 104 process the I/O requests so that user data is written to or read from the appropriate storage locations in the storage arrays 106. As used herein, the term “user data” refers to data that a person or entity might use in the course of business performing a job function or for personal use. Such user data may be business data and reports, Web pages, user files, image files, video files, audio files, software applications, or any other similar type of data that a user may wish to save to storage.

The storage arrays 106 may include various types of persistent storage including drives 112. Each storage array 106 may include multiple drives 112. Certain drives 112 may be owned by particular respective controllers 104. Moreover, some of the drives 112 may be relatively fast and expensive drives such as solid-state disks or drives (SSD), flash memory, or other high-performance drives. Such high-performance drives may be employed for the more demanding storage tiers or higher storage tier levels. In contrast, some of the drives 112 may be relatively slow and less expensive drives such as Serial Advanced Technology Attachment (SATA) hard disk drives (HOD) and other lower-performance drives. Such cheaper and lower-performance drives may be employed for less demanding storage tiers or lower storage tier levels. The drives 112 may be other types of drives and disks, hybrid disks, and so forth, and which are employed as persistent storage in the storage array 106 including for different storage tiers. The number of levels of storage tiers may range from 2 to 5 or 6, for instance. Moreover, employed RAID levels may be incorporated as part of the storage tier classification or level, and impact cost and speed.

In examples, a given controller node 104 may control a section (particular disks) of each storage array 106, or own particular sections(s) or disks of one or more storage arrays 206. The ownership may be carved out logically, as logical disks. In certain examples, ownership may be distributed across all or most of the controller nodes 104.

In one example for a given storage array 106 having nine disks 112, a controller node 104 controls three disks (e.g., disks, 1, 2, 3), another controller node 104 controls three disks (e.g., disks, 4, 5, 6), and a third control node 104 control the remaining three disks (e.g., disks, 7, 8, 9). Of course, other configurations and arrangements of the controller nodes 104 with respect to storage arrays 106 and the disks 112 are contemplated and implemented.

In examples, the controller node 104 that owns the affected disks 112 of the storage volume or arrays 106 in the adaptive optimization or data movement in storage tiering may perform the data movement. That controller node 104 may also perform the associated storing of a new virtualization map in CPU cache 206 and other related actions, without a related blocking of the host I/O or host I/O request. Indeed, in examples, a controller node 104 may create caches for the logical disks it has ownership. Yet, a controller node 104 may not have a relevant cache page 112 data structure for its logical disks. Again, other arrangements are considered.

Lastly, it will be appreciated that the storage system 100 shown in FIG. 1 is only one example of a storage system in accordance with embodiments. In an actual implementation, the storage system 100 may include various additional storage devices and networks, which may be interconnected in various fashions, depending on the design considerations of a particular implementation. A large storage system will often include many more storage arrays 106 and controller nodes 104 than depicted in FIG. 1. Further, the storage system 100 may provide data services to many more client computers 102 than in the illustration.

As mentioned, storage tiering may involve moving data between fast and slow storage tiers based on data access patterns. Such data movements may involve changing the virtualization maps in the storage system. Storage systems can block client or host I/O and invalidate caches when installing new virtualization maps. However, blocking host I/O can cause client or host applications to see degraded I/O response time. Invalidating the cache can also cause read/write latency to be adversely increased as the cache may generally need to be warmed again. In contrast, as discussed further below, examples herein provide for installation of new virtualization maps in the storage controllers without cache invalidation and without blocking client or host I/O.

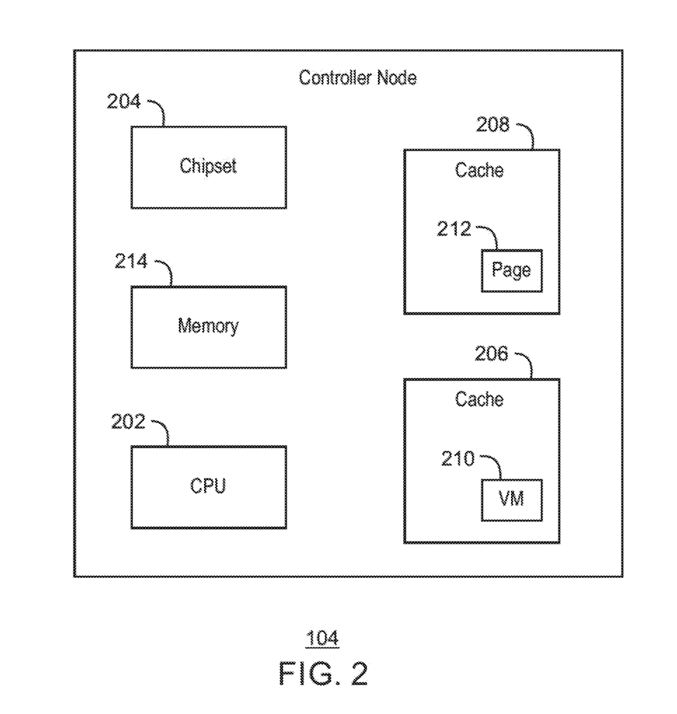

FIG. 2 is an exemplary controller node 104 having one or more processors such as central processing units (CPUs) 202, and also a chipset 204, to facilitate management and control of a storage array 106 or drives 112 in one or more storage arrays 106 (see FIG. 1). In examples, a controller node 104 may own particular drives 112. Other arrangements are also possible depending on the design considerations of a particular implementation. Additionally, certain details of the storage system 100 configuration can be specified by an administrator, and so forth.

A controller node 104 may include one or more cache memory, among other memory. In the illustrated example, the controller node 104 has at least a cache memory 206 associated with or owned by a CPU 202, and at least a cache memory 208 associated with or owned by the chipset 204. Of course, the controller node 104 includes additional features.

In the illustrated example, the cache memory 206 associated with the CPU 202 may store a virtualization map 210 and other cached data. In examples, the virtualization map 210 may be a virtualization map dynamically installed or updated during data movement in the adaptive management or optimization with storage tiers based on access patterns and other factors. The new virtualization map 210 created in the cache memory 206 may include the logical disk offset associated with the data movement. Such a new virtualization map 210 may be created in the cache 206 without substantially blocking or adversely affecting host I/O. Moreover, the virtualization maps 210 may be at a global or volume manager level, such as with the mapping of virtual volumes to logical disks.

As for the cache memory 208 associated with the chipset 204 in this example, the cache memory 208 may store a page cache data 212 structure and other cached data. As discussed below, the page cache data 212 may be updated or created on demand later in time via host I/O requests after the storage-tiering data movement. As indicated, such on-demand updates or creation of the cache page 212 may be facilitated by the storing of a timestamp data in the CPU cache 206 to represent the data movement. The timestamp may be a monotonically increasing number. In one example, the timestamp is based on CPU clock ticks. Other actions that may initiate update of page cache data 212 include the flushing of virtualization maps 210 (at the volume management layer relating volumes to logical disks) to the backend where localized virtualization maps (at the logical disk layer) relating logical disks to actual physical disks may be updated or created.

The controller node 104 may include memory 214 to store code executable by the one or more CPUs 202 or other processors to direct the storage system to implement techniques described herein. The memory 214 may include nonvolatile and volatile memory. Code may also be stored in the disk arrays 106 and other memory.

As discussed, storage tiering may involve moving data between fast and slow storage tiers based on data access patterns. Such data movements or data migration may encompass changing the virtualization maps in the storage system. Again, storage systems can block host I/O and invalidate caches when installing new virtualization maps. This can cause host applications to see degraded I/O response time while the host I/O is blocked. Invalidating the cache can also cause read/write latency. Conversely, some examples herein provide for installation of new virtualization maps in the storage controllers or controller nodes 104 without certain cache invalidation and without blocking host I/O, and thus without significant adverse impact on host I/O response time by the storage system 100. When data is moved for storage tiering, the data regions in the source tier and the destination tier may typically be owned by the same storage controller or controller node 104 in certain examples.

When the source and destination regions are owned by the same controller node 104, or in similar configurations, certain examples avoid host I/O blocking and cache invalidation, or substantially avoid these latter two actions. Initially, the process of moving data between storage tiers may be include copying data from the source region to the destination region. The affected storage volume(s) may remain online and servicing I/O requests while this copying is progressing. New write data received at the controller node 104 during this phase may be written to both the source region and the destination region. In other words the new write data during this time may be mirrored to source and destination regions.

Once the copying is complete, or the source and data regions are in sync, the virtual or virtualization maps on most or all controller nodes 104, e.g., in the CPU cache 206, are changed so that the maps now point to the destination region as the storage location for the moved data. Contemporaneously or close in time, timestamps associated with the source and destination regions are updated, such as in cache (e.g., cache memory 206 or 208) of the controller node 104. In examples, the updated timestamp may be a dynamic trigger.

In other words, updating the timestamps associated with the source and destination regions may cause clean cache data to be detected by the controller node 104 and CPU 202 as stale. The controller node 104 and one or more CPUs 202 may also detect dirty data in the cache memory (e.g., cache memory 206 and 208) via mismatched timestamps, and may relookup the virtualization maps to obtain the new home location of the data.

The code stored in memory 214 or in other memory associated with the controller node 104 and executable by the one or more CPUs 202 or other processors may direct the storage system to implement the aforementioned features. For example, the code may direct the storage system 100 and controller node 104 in the adaptive optimization of storage-tiering and the associated movement of data between storage tiers and logical disks. The code executed by the CPU 202 may direct the mirroring of any write data (during the storage-tiering copying) to both the source and destination regions, update virtualization maps 210 and timestamps (in the cache memory 206, for instance) associated with the source and destination regions, and subsequently direct the updating or creation of page cache data 212 structures on-demand at the time of host I/O requests, for example, and so forth.

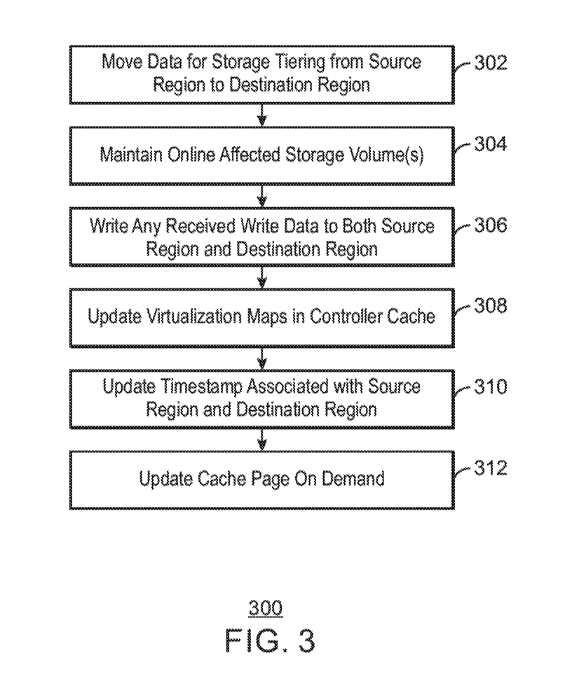

FIG. 3 is a method 300 of operating a storage system, such as the storage system 100 of FIG. 1 having controller nodes 104 such as the controller node 104 of FIG. 2. The method 300 includes moving (block 302) data from a storage source region to a storage destination region, such as in response to storage-tiering adjustment of data location based on data access patterns. The source and destination regions may be logical regions of logical volumes or disks, or physical regions or disk drives, and so on. Further, the moving (block 302) of the data may involve copying the data, and then after copying is complete and associated virtualization maps in the controller node cache updated, the copied data deleted from the source region.

Advantageously, during the moving and copying of the data, the affected storage volumes having the source and destination regions may be maintained (block 304) online and available to clients and hosts. Indeed, host I/O requests for access to source or destination regions may be accommodated and not blocked. Further, during the copying and moving of the data for adaptive storage-tiering, any new write data received at the controller nodes may be written (block 306) to both the source region and destination region. In other words, during the storage-tiering copying and moving of data, any received write data from a host may be mirrored to the source and destination regions.

Also, during or soon after this copying phase, the virtualization maps, such as in controller cache, may be updated (block 308) to reflect the offset and new location of the moved data. The virtualization maps (e.g., at the volume manager level relating or mapping volumes to logical disks) on the controller nodes are changed so that the maps now point to the destination region as the storage location for the moved data. At the same or similar time, timestamps associated with the source and destination regions may updated (block 310) in the controller node. In particular, timestamps associated with the source and destination regions may be updated, such as in cache (e.g., cache memory 206 or 208) of the controller node 104. The timestamp may be a monotonically increasing number and may be based on CPU clock ticks, for example.

Further, the updated timestamp may be a dynamic trigger in certain examples. In other words, after movement of the data and updating of the virtualization maps and timestamps, the page cache data structure may be accessed and updated (block 314) on-demand in response to host I/O requests. In other words, a page cache data structure may be updated on a need basis. Once the storage-tiering copying of data is complete, updating the timestamps associated with the source and destination regions may cause clean cache data to be detected stale, and dirty cache data detected via mismatched timestamp. Actions that may initiate update of page cache data may include the flushing of virtualization maps to the backend where localized virtualization maps (at the logical disk layer) relating logical disks to actual physical disks may be updated or created.

In summary, data movement with the dynamic or adaptive enhancement of data location with regard to the storage tiers based on data access patterns and other factors may be practiced without substantial cache invalidation or without blocking host I/O requests. Lastly, as mentioned for particular example, the techniques may be implemented in a distributed shared-nothing or shared-little architectures, or other architectures, where data is striped across multiple controllers providing read and write caching, for instance.

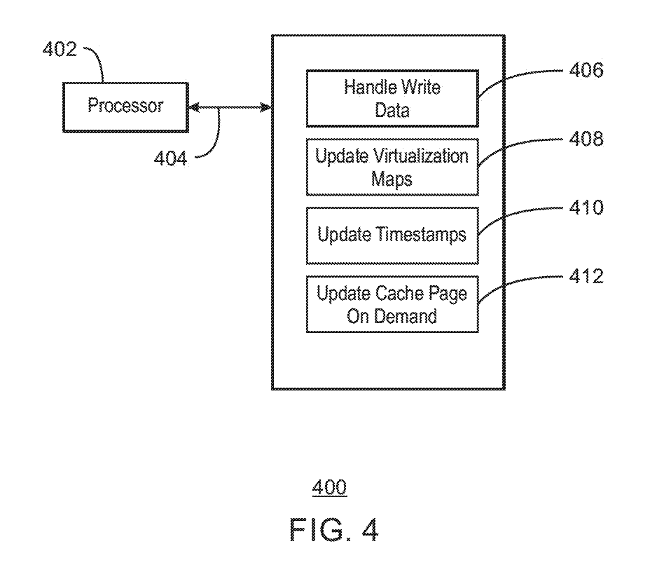

FIG. 4 is a block diagram showing a tangible, non-transitory, computer-readable medium that stores code configured to operate a data storage system. The computer-readable medium is referred to by the reference number 400. The computer-readable medium 400 can include RAM, a hard disk drive, an array of hard disk drives, an optical drive, an array of optical drives, a non-volatile memory, a flash drive, a digital versatile disk (DVD), or a compact disk (CD), among others. The computer-readable medium 400 may be accessed by a processor 402 over a computer bus 404. Furthermore, the computer-readable medium 400 may include code configured to perform the methods described herein. The computer readable medium 400 may be the memory 214 of FIG. 2 in certain examples. The computer readable medium 400 may include firmware that is executed by a storage controller such as the controller nodes 104 of FIG. 1.

The various software components discussed herein may be stored on the computer-readable medium 400. The software components may include the moving and copying of data from a source region to a destination region in response to adaptive storage-tiering based on data access patterns, for example. A potion 406 of the computer-readable medium 400 can include a module or executable code that directs a processor such as a CPU 212 in the controller node 104 to mirror any new write data during the storage-tiering moving do data to both the source and destination regions. A portion 408 can include a module or executable code that updates the virtualization maps in controller node 104 cache during the copying or after the copying is complete. Similarly, a portion 410 may include a module or executable code that updates timestamps associated with the source and destination regions once the copying is complete. Lastly, a portion 412 of the computer-readable medium 400 may include a module or executable code to update page cache data structure on demand.

Although shown as contiguous blocks, the software components can be stored in any order or configuration. For example, if the tangible, non-transitory, computer-readable medium is a hard drive, the software components can be stored in non-contiguous, or even overlapping, sectors.

Lastly, an example of method may include determining via a processor (e.g., CPU of a controller node) to move data based on access patterns to the data from a first storage tier having the source region to a second storage tier having the destination region. The example method includes copying the data via the processor from the source region to the destination region (e.g., without blocking an I/O request). The method includes updating in cache associated with the processor a source region timestamp and a destination region timestamp. The logical storage volume(s) having the source region and the destination region may be maintained online during the copying. The example method may include installing via the processor a virtualization map in the cache associated with the processor without blocking an input/output (I/O) request, the virtualization map reflecting the destination region as a location of the data. Further, during the copying, the processor may write received write data to both the source region and the destination region. Additionally, after the copying of the data is complete, the processor may update a cache page data structure on-demand in response to an I/O request, wherein updating the cache page data structure may be facilitated via at least one of the source region timestamp or the destination region timestamp.

An example storage system includes storage arrays having storage disks, and controller nodes to control the storage arrays. The controller nodes include a processor and memory storing code executable by the processor to: (1) copy data from a source region to a destination region; (2) install a virtualization map in cache associated with the processor, the virtualization map reflecting the destination region as a location of the data; and (3) update in the cache a source region timestamp and a destination region timestamp. The memory may store code executable by the processor to determine at the outset to move the data from a first storage tier (having the source region) to a second storage tier (having the destination region) based on access patterns to the data. The memory may store code executable by the processor to maintain online the source region and the destination region during the copying, and to install the virtualization map in the cache and reflecting the destination region as a location of the data. Such may be performed without blocking an input/output (I/O) request. The memory may store code executable by the processor to store write data received at the processor to both the source region and the destination region during the copying, and to update after the copying is complete a cache page data structure on-demand in response to an I/O request.

In another example, a tangible, non-transitory, computer-readable medium stored instructions that direct a processor to: copy data from a source region to a destination region; mirror received write data to the source region and the destination region; install a virtualization map in cache associated with the processor, the virtualization map reflecting the destination region as a location of the data; update in the cache a source region timestamp and a destination region timestamp; and update a cache page data structure on-demand in response to an I/O request. Further, contemporaneous with copying of the data from the source region to the destination region, and contemporaneous with the virtualization map being installed in the cache, the storage region and the destination region are maintained online, and a host input/output (I/O) request affecting the source region or the destination region is not blocked.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A method comprising:
determining via a processor to move data based on access patterns to the data from a first storage tier comprising a source region to a second storage tier comprising a destination region;
copying the data via the processor from the source region to the destination region; and
updating in cache associated with the processor a source region timestamp and a destination region timestamp.

2. The method of claim 1, comprising maintaining online logical storage volumes comprising the source region and the destination region during the copying.

3. The method of claim 1, wherein the processor comprises a central processing unit (CPU) of a controller node.

4. The method of claim 1, comprising installing via the processor a virtualization map in the cache associated with the processor without blocking an input/output (I/O) request, the virtualization map reflecting the destination region as a location of the data.

5. The method of claim 1, comprising, during the copying, writing via the processor write data received at the processor to both the source region and the destination region.

6. The method of claim 1, wherein copying the data comprises copying the data from the source region to the destination region without blocking an I/O request.

7. The method of claim 1, comprising after the copying of the data is complete, updating via the processor a cache page data structure on-demand in response to an I/O request.

8. The method of claim 7, wherein updating the cache page data structure is facilitated via at least one of the source region timestamp or the destination region timestamp.

9. A storage system comprising:
storage arrays having storage disks; and
controller nodes to control the storage arrays, the controller nodes comprising a processor and memory storing code executable by the processor to:
copy data from a source region to a destination region;
install a virtualization map in cache associated with the processor, the virtualization map reflecting the destination region as a location of the data; and
update in the cache a source region timestamp and a destination region timestamp.

10. The storage system of claim 9, wherein the memory to store code executable by the processor to determine to move the data from a first storage tier comprising the source region to a second storage tier comprising the destination region based on access patterns to the data.

11. The storage system of claim 9, wherein the memory to store code executable by the processor to maintain online the source region and the destination region during the copying.

12. The storage system of claim 9, wherein the memory to store code executable by the processor to install the virtualization map in the cache and reflecting the destination region as a location of the data without blocking an input/output (I/O) request.

13. The storage system of claim 9, wherein the memory to store code executable by the processor to store write data received at the processor to both the source region and the destination region during the copying, and to update after the copying is complete a cache page data structure on-demand in response to an I/O request.

14. A tangible, non-transitory, computer-readable medium comprising instructions that direct a processor to:
copy data from a source region to a destination region;
mirror received write data to the source region and the destination region;
install a virtualization map in cache associated with the processor, the virtualization map reflecting the destination region as a location of the data;
update in the cache a source region timestamp and a destination region timestamp; and
update a cache page data structure on-demand in response to an I/O request.

15. The computer-readable medium of claim 14, wherein contemporaneous with copying of the data from the source region to the destination region, and contemporaneous with the virtualization map being installed in the cache, the storage region and the destination region are maintained online, and a host input/output (I/O) request affecting the source region or the destination region is not blocked.
